(19) United States
(12) Patent Application Publication
(10) Pub. No.: US 2009/0099890 A1
(43) Pub. Date: Apr. 16, 2009

(54) WEB BASED SYSTEM, METHOD AND COMPUTER WRITEABLE MEDIUM FOR MANAGEMENT OF COMMERCIAL REAL ESTATE SIGNAGE INCLUDING ORDERING/TERMS AND PLACEMENT

(76) Inventor: Robby Ash, Waterford, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/233,028

(22) Filed: Sep. 18, 2008

Related U.S. Application Data
(60) Provisional application No. 60/974,317, filed on Sep. 21, 2007.

(51) Int. Cl. G06Q 30/00; G06Q 10/00; G06F 3/048; G06Q 50/00

(52) U.S. Cl. 705/7; 705/27; 715/772; 715/739

(57) ABSTRACT

An online system and associated computer writeable medium for managing residential and commercial signage, including the step of customer order placement in the creation and installation of any plurality of signage. The system includes a series of web based illustrations for managing the specifications associated with the created signage, as well as installation specifics and removal.

### CROSS-REFERENCE TO RELATED APPLICATIONS

This Application is a Non-Prov of Prov (35 USC 119(e)) application 60/974,317 filed on Sep. 21, 2007 and entitled WEB BASED SYSTEM, METHOD AND COMPUTER WRITEABLE MEDIUM FOR MANAGEMENT OF RESIDENTIAL AND COMMERCIAL REAL ESTATE SIGNAGE INCLUDING ORDERING/TERMS AND PLACEMENT.

### FIELD OF THE INVENTION

The present invention generally relates to a web-based online management system for residential and commercial signage. More specifically, the present invention discloses a comprehensive sign ordering, placement and management system, such as for use by real estate professionals. Advantages of the sign ordering and management system, method, and computer writeable medium include the ability to place orders for any number of signs (singular or in bulk), track location/placement and installation status, view/edit/add verbiage or graphics either before or following sign placement, post removal/repair notices, automated analysis and confirmation applicable local (city/county) restrictions.

### BACKGROUND OF THE INVENTION

Residential and commercial applications for ordering and placing signage is known in the prior art. A notable application in particular is the requesting and installation of residential and commercial signage for lease and sales of real estate properties (including homes, businesses, and land).

Conventional signage and installation requests are normally processed by written, telephonic and fax request. As a result, such applications are time consuming, inefficient and, unless carefully monitored and managed, provide many opportunities for error resulting in incorrect sign dimensions, graphics and the like.

### SUMMARY OF THE INVENTION

The present invention discloses an online system for managing residential and commercial signage. The system includes at least one computer, or other suitable processor operated device control, including such as desktop/laptop computer, hand-held personal digital assistant (pda) or multi-functional communication device (e.g. Iphone® or Blackberry®) which is utilized by a customer in the placement of an order relative to the creation and installation of any plurality of signage. More particularly, the system and associated computer writeable medium provide easier and more efficient ordering and management of commercial signage than which is currently available with existing systems and programs.

The system includes a series of web based illustrations for managing the specifications associated with the created signage, as well as installation specifics and removal. Additional ordering features include a signage repair/update request form. An order detail page provides an administrator with complete access to an entire program associated with the system from a single page. The order detail page includes any of the ability to review order details, attach completed job photos and update progress of order for customer and associates in the associated order status section, as well as viewable sections for production, installation, updating and processing of order. A local ordinance restriction filter database screen compares all relevant city/township/country regulations and codes pertaining to allowable signage parameters.

An administration item list screen presents customer price lists, this including all items which are required in order to calculate the cost of each order/request, and further including size and pricing for any individual (or all) customers. A customer job status screen is further provided, and by which customers can obtain real time job status of all orders placed, along with completed job/installation photographs. The customer order and installation screen includes sub-fields by which all relevant information relating to an installation is added by the customer.

The invention also discloses a computer writeable medium for an online system for managing residential and commercial signage including a first customer accessible subroutine for requesting creation and installation of any plurality of signage, and including any of signage size, script, installation type and location, term of installation, repair/update, and removal. A second administrator viewable subroutine provides the ability to review order details, attach completed job photos and update progress of order for customer and associates in the associated order status section, as well as viewable sections for production, installation, updating and processing of order. A third restriction filter subroutine compares all relevant city/township/country regulations/codes/ordinances pertaining to allowable signage parameters, with a fourth administration item list subroutine presenting customer price lists including all items which are required in order to calculate the cost of each order/request, and further including size and pricing for individual or all customers.

Additionally included is a customer job status subroutine, and by which customers can obtain real time job status of all orders placed, along with completed job/installation photographs. The first customer accessible subroutine further includes customer order and installation capability with sub-fields by which all relevant information relating to an installation is added by the customer.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an illustration of an item of signage created according to the system, method and computer writeable medium of the present invention;

FIG. 1A is an illustration of a processor driven device in communication, via a network, with a remote processor database;

FIG. 2 is a similar illustration to that shown in FIG. 1 of an alternate signage example, and further illustrating the features of script dimensions, associated grade and the like;

FIG. 3 is an illustration of an administration sign order page forming a component of the on-line based signage management system and which provides the administrator with complete access to the entire program from a single page, including the ability to review such features as order details, attach completed job photos and update progress of order for customer and associates in the associated order status section, as well as viewable sections for production, installation, updating and processing of order;

FIG. 4 is an illustration of a city restrictions filter database screen and which illustrates the fashion in which each order/installation is filtered through a city restriction database including all relevant city/township/country regulations and codes pertaining to allowable signage parameters;

FIG. 5 is an administration item list screen presenting customer price lists including all items which are required in order to calculate the cost of each order/request, this also incorporating the ability to add details including size and pricing for individual or all customers;

FIG. 6 is a customer job status screen and by which customers can obtain real time job status of all orders placed, along with completed job/installation photographs;

FIG. 7 is a customer order and installation screen, and by which all relevant information relating to an installation is added by the customer; an additional feature referencing a corresponding removal request page, and by which a user is permitted to click on a previously ordered installation, the details of which are retrieved from that order and automatically entered into relative fields;

FIG. 8 a screen illustration of a customer order page and at which all customer service requests can be accessed;

FIGS. 9A-9E present a series of illustrations of installation specifications provided to a client for approval upon proposal acceptance;

FIG. 10 is an art details page for customer execution upon proposal acceptance;

FIG. 11 is an installation quality field check form;

FIG. 12 is a product and quality guarantee page.

FIG. 13 is a proposal acceptance term and agreement page; and

FIG. 14 is an auxiliary signage order request form for use in the event of interruption to the on-line/web based system.

### DETAILED DESCRIPTION OF THE PREFERRED EMBODIMENTS

As previously described, the present invention discloses a comprehensive residential and commercial signage system, method and associated program/computer writeable medium, in particular pertaining to aspects including ordering, placement and management of signage, and such as for use by real estate professionals. As will be described in additional detail throughout the following disclosure, advantages of the sign ordering and management system, method, and computer writeable medium include the ability to place orders for any number of signs (singular or in bulk), track location/placement and installation status, view/edit/add verbiage or graphics either before or following sign placement, post removal/repair notices, automated analysis and confirmation applicable local (city/county) restrictions.

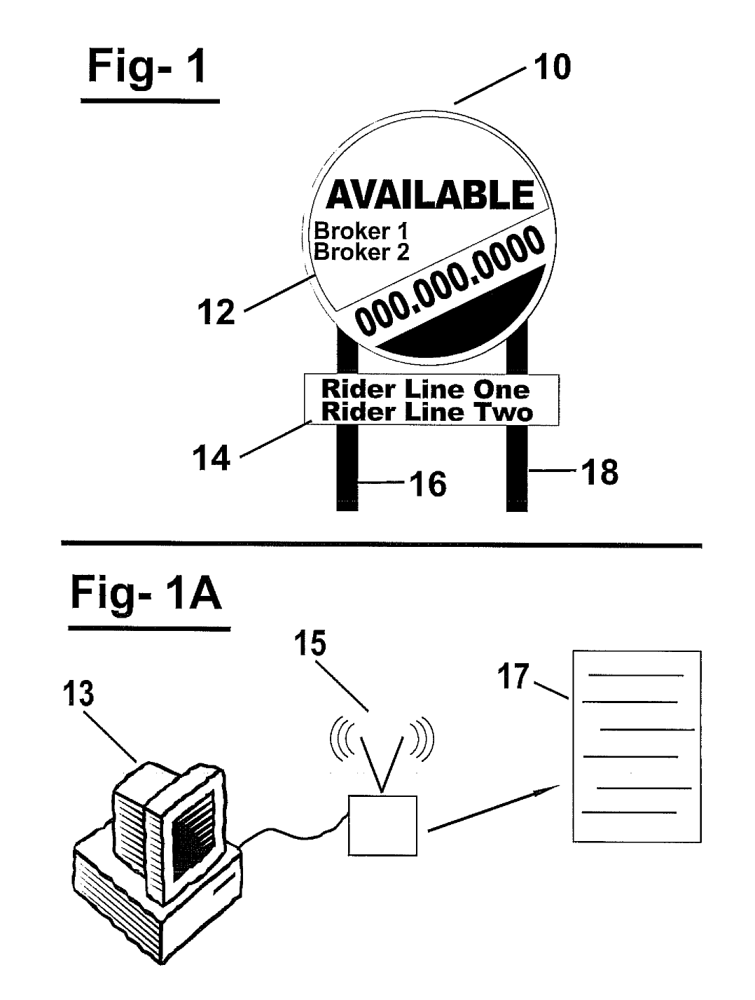

Referring first to FIG. 1, an illustration is shown at 10 of an item of signage created according to the system, method and computer writeable medium of the present invention. In particular, the item of signage exhibited includes a main display area 12 and a secondary detached display area 14, these being supported by common mounting posts 16 and 18.

Referring to FIG. 1A, a schematic of a processor driven device, see at 13, is illustrated in two-way communication, via a network generally represented at 15 and such as provided by wireless Internet based connection, with a remote processor database 17. The processor driven device 13 is intended to represent a computer, or other suitable processor operated device control, including such as desktop/laptop computer, hand-held personal digital assistant (pda) or multi-functional communication device (e.g. Iphone® or Blackberry®) which is utilized by a customer in the placement of an order relative to the creation and installation of any plurality of signage.

The remote processor database 17 is further understood to include any type of remote computer or data server, such as which is conventionally known for supporting a web program through which the system and associated computer writeable medium can operate. It is also understood that other communication technologies or protocols, outside of or in addition to a standard web-based program, can also be exploited by the present invention, this including suitable wireless (such as Internet connected or otherwise) or other communication networks which are employed by such portable PC devices as previously recited.

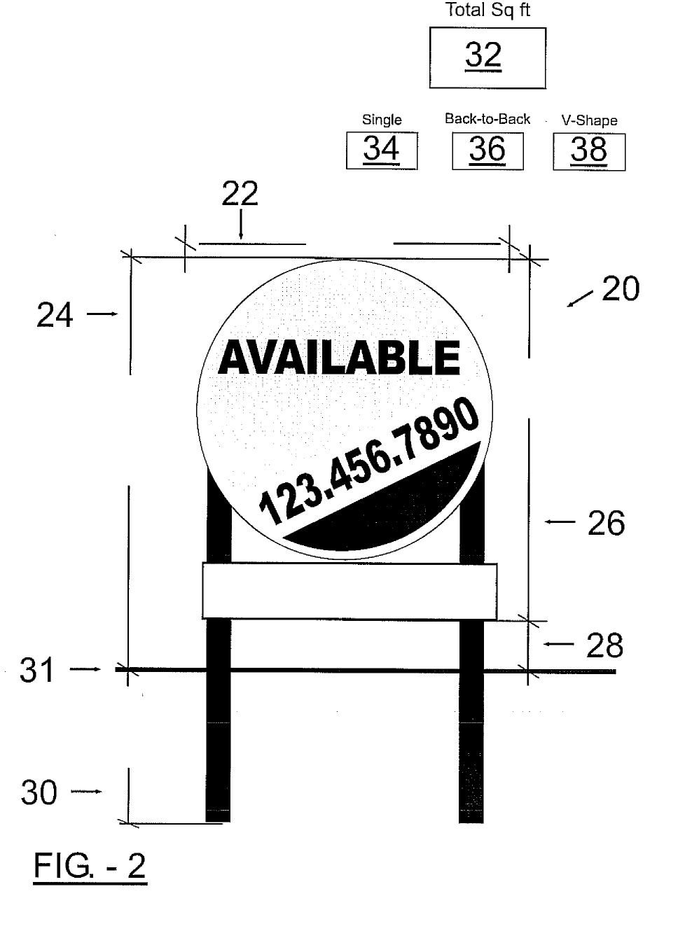

FIG. 2 is a similar illustration, see at 20, in comparison to that shown at 10 in FIG. 1, of an alternate signage example. The sign 20 further illustrates the features of various script supporting dimensions, see at 22, 24, 26 and 28, as well as associated grade indication 30 (this corresponding to a depth extending below a surface grade location 31).

The sign 20 can define an illustration contained within a web screen corresponding to the illustration of FIG. 2, and which operates as a permit application template. The screen 20 further includes entry forms corresponding to total square footage (of sign) 32, including options for single 34, back-to-back 36 and V-shape (i.e. identifying a type of reinforced support bracket) 38 signage. It is again understood that the illustrations of FIGS. 1 and 2 can be incorporated as viewable web pages in the associated on-line program, although it is further understood that components of the sign ordering and management can also operate outside of the confines of an entirely web based system as previously suggested.

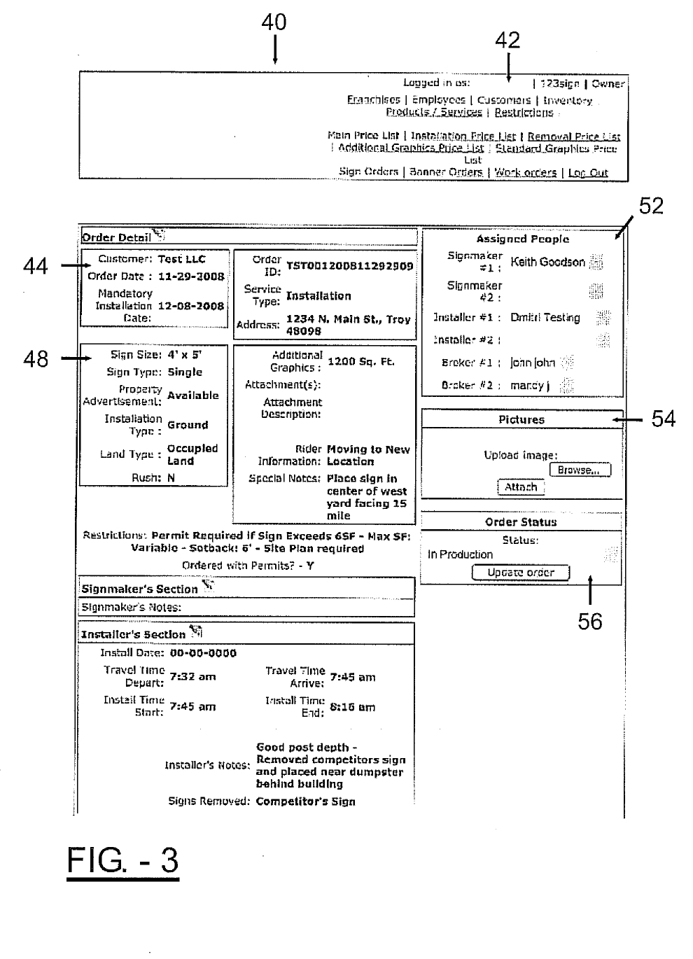

Referring now to FIG. 3, an illustration is shown at 40 of an administration sign order page forming a component of the on-line based signage management system. As previously described, the admin sign order page 40 provides the administrator with complete access to the entire program from a single on-line viewable page, including the ability to review such features as order details, attach completed job photos and update progress of order for customer and associates in the associated order status section, as well as viewable sections for production, installation, updating and processing of order. Relevant fields included in the form 40 include login name/password 42, customer/order date/installation date 44, order ID number 46, signage specifications 48, replacement/repair/update requests 50, project staff assignments (sign makers, installers, brokers) 52, uploaded images 54, order status 56, sign maker's notes 58 and installer's notes 60.

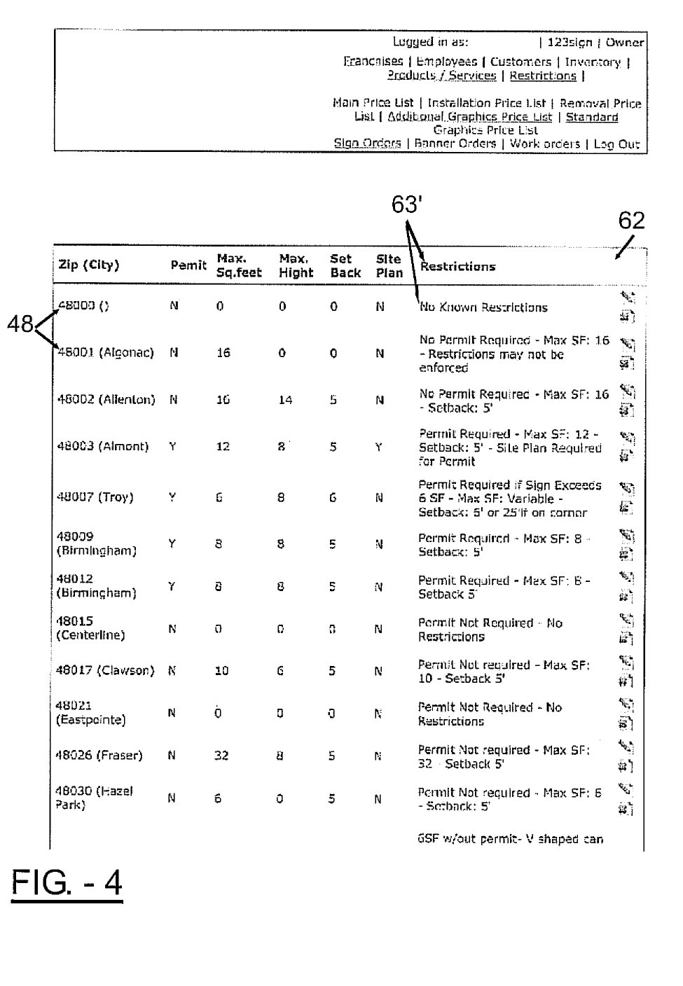

FIG. 4 is an illustration 62 of a city restrictions filter database screen and which illustrates the fashion in which each order/installation is filtered through a city restriction (see as identified by a listing of geographic zip codes at 63) database including all relevant city/township/country regulations 63′ and codes pertaining to allowable signage parameters. An important aspect of the system and associated computer writeable medium is that it incorporates all relevant signage ordinances, codes and regulations and further such that, upon a user entering all relevant request fields, the system can determine if 1) the relevant local ordinances allow for a sign of the given (e.g. maximum) dimensions and, if so, 2) is a permit required.

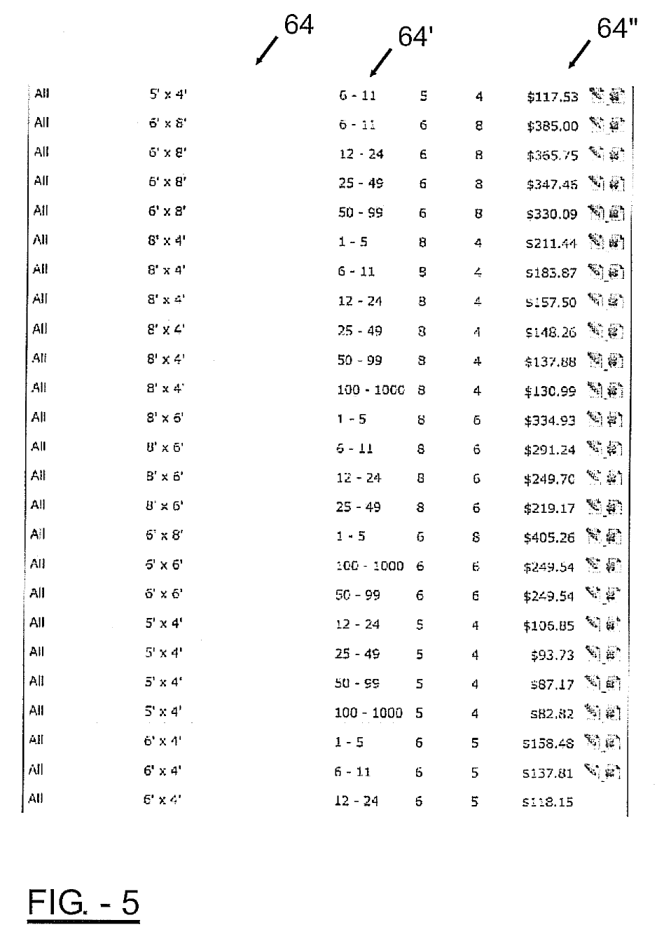

Referring now to FIG. 5, an administration item list screen 64 presents customer price lists, including all items which are required in order to calculate the cost of each order/request. The price list screen 64 additionally incorporates such details as including size 64′ and pricing 64″ for individual or all customers.

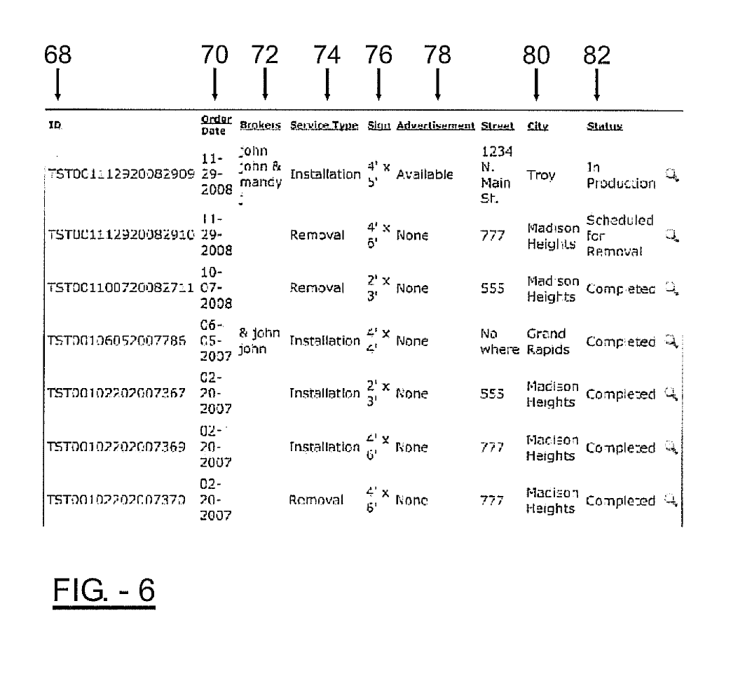

FIG. 6 illustrates, at 66, a customer job status screen and by which customers can obtain real time job status of all orders placed, along with completed job/installation photographs. The ability of the customer to obtain real time updates of a given job are of particular benefit to the administrator of the system, and which greatly reduces the incidences of telephone follow up. Sub-fields incorporated into the job status screen 66 include those for job ID 68, order date 70, broker(s) 72, service type 74, sign size 76, advertisement 78, street 80, city 82 and status 84.

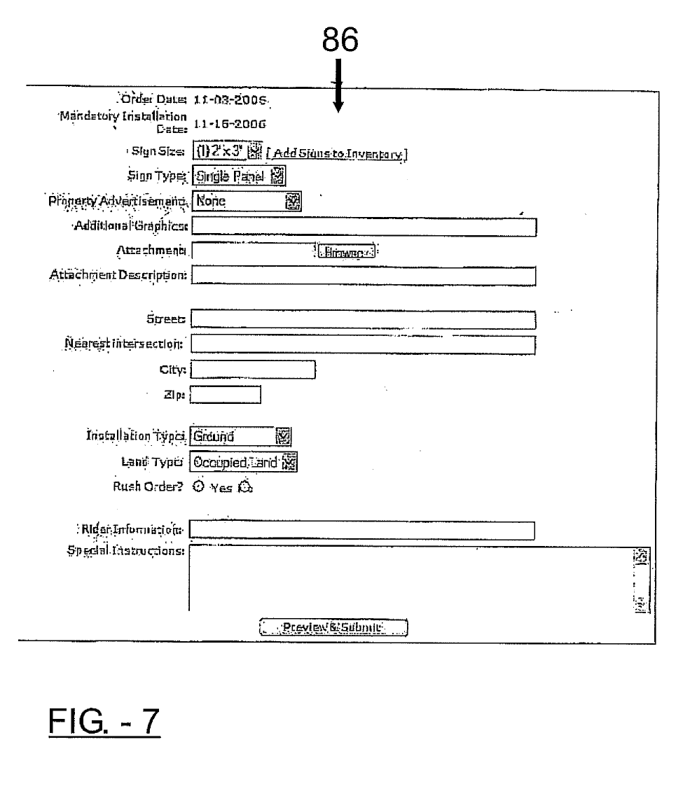

Referencing now FIG. 7, a customer order and installation screen 86 shown, and by which all relevant information relating to an installation is added by the customer. As referenced, a number of fields are shown in the screen illustration 86, these including for customizing sign type, script, size, description, type of installation, address, installation type, land type, as well as additional instructions. As also referenced previously, an additional feature references another corresponding removal request page, and by which a user is permitted to click on a previously ordered installation, the details of which are retrieved from that order and automatically entered into relative fields.

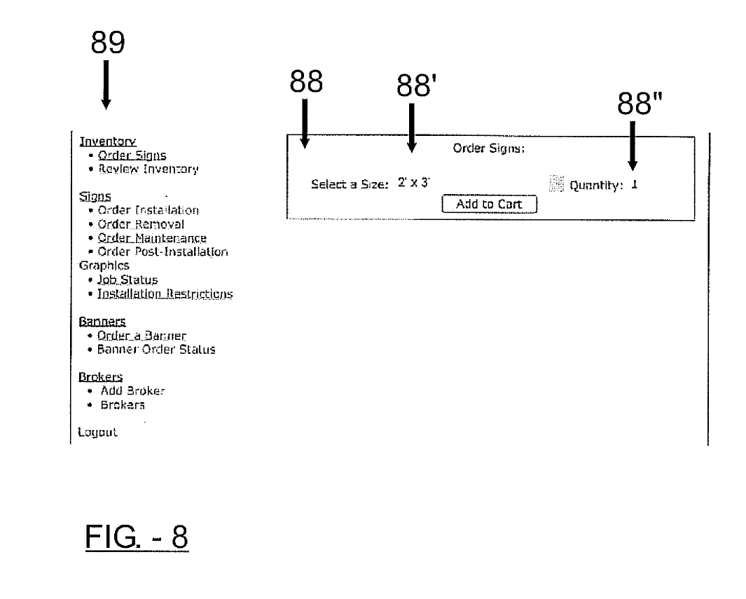

FIG. 8 is a screen illustration 88 of a customer order page, and at which all customer service requests can be accessed. This is particularly useful to such as a system administrator and by which sign ordering information includes both size 88′ and quantity 88″ entry fields. A series of jump-site commands, see as generally referenced at 89, can be placed at a location on the specified screen 88 and can include such as covered under Inventory, Signs, Banners, Other and Logout designations.

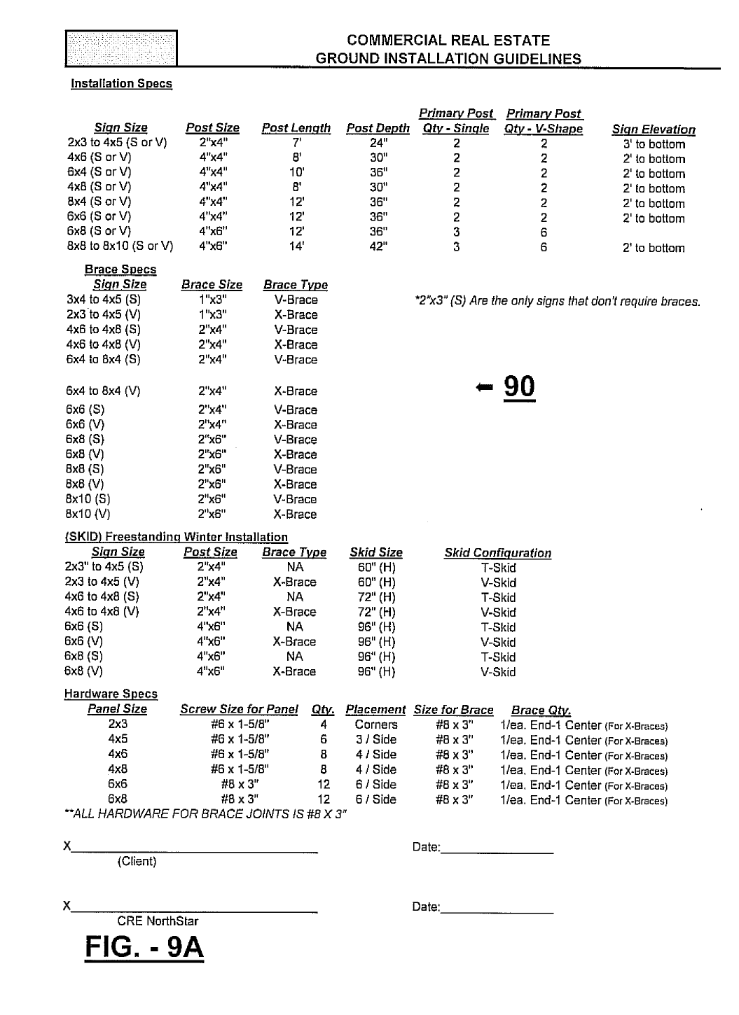

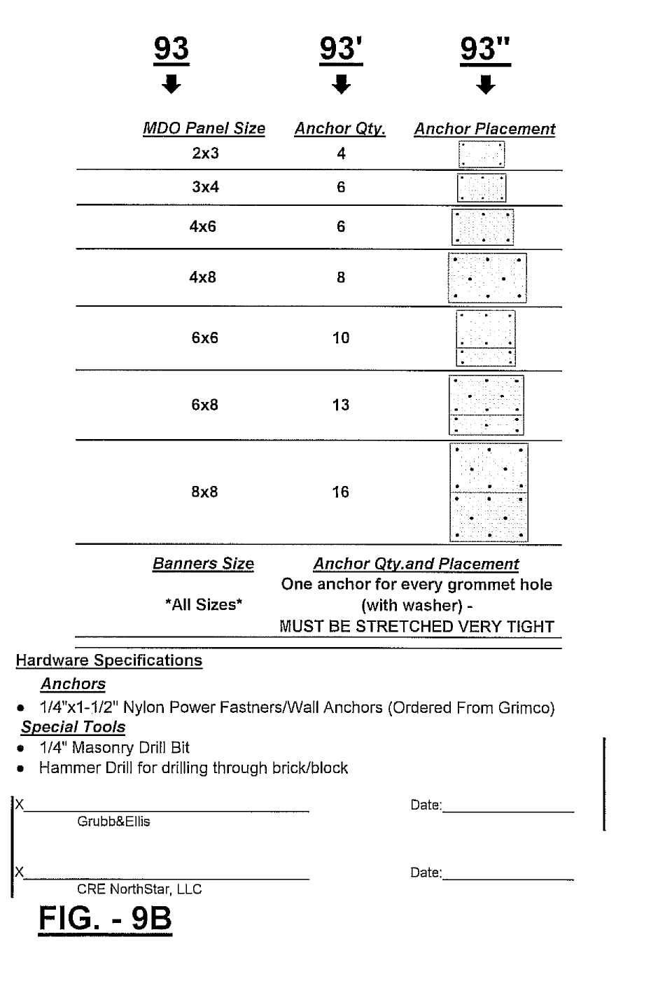

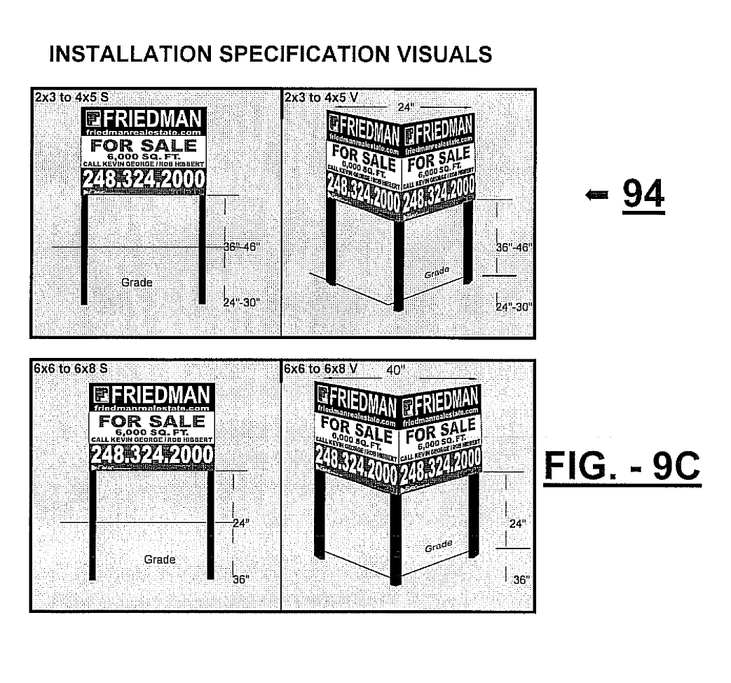

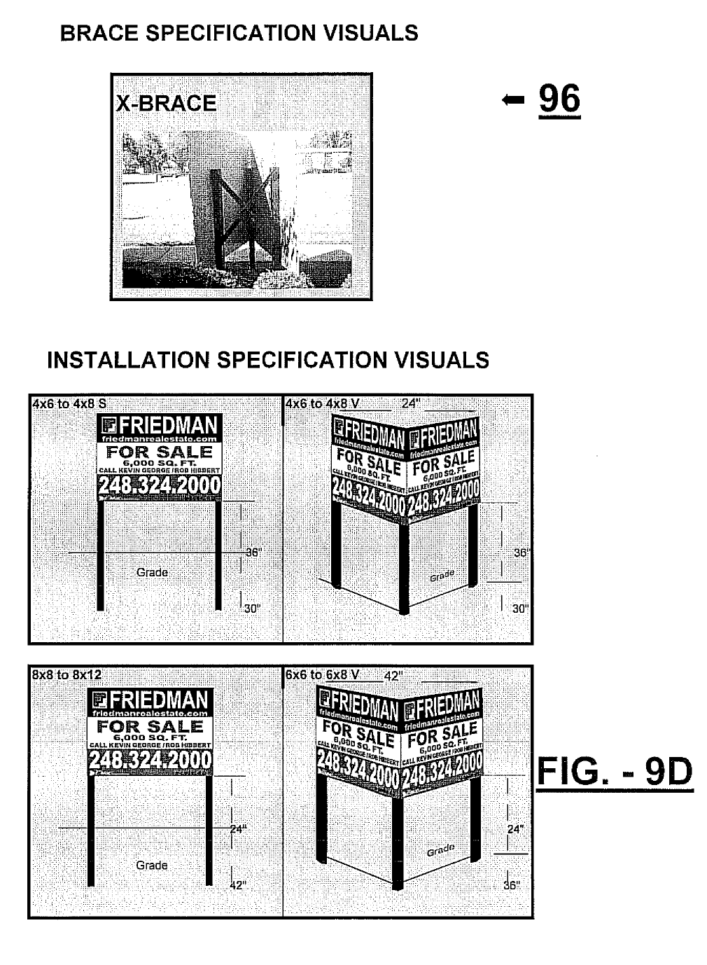

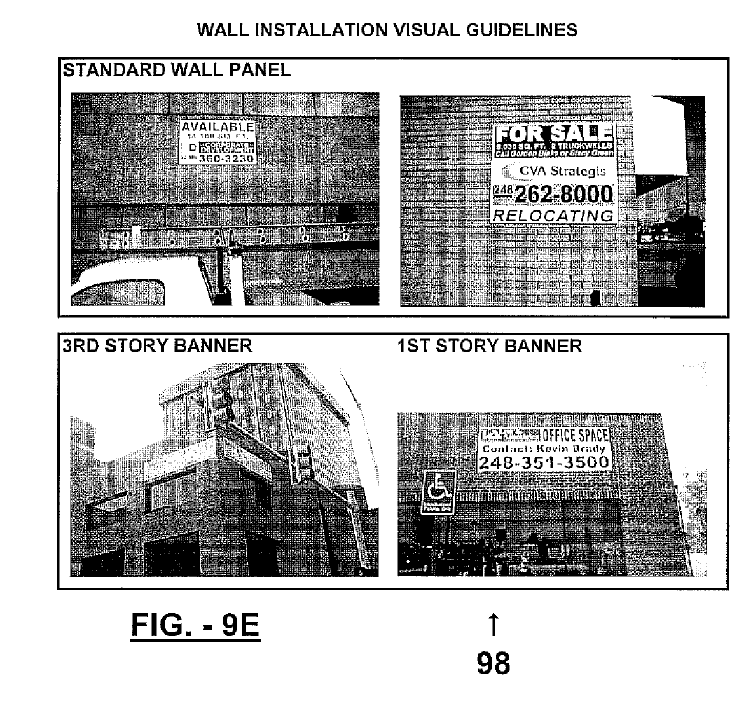

FIGS. 9A-9E present a series of illustrations 90, 92, 94, 96 and 98 of installation specifications provided to a client for approval upon proposal acceptance. Addressing each of these pages in succession, illustration 90 (FIG. 9A) references a commercial real estate ground installation guideline page and which sets forth the various requirements associated with any given sign installation. These include such terms known in the relevant art and including sign size, post size, post length, post depth, primary post quantity (single or V-shape), sign elevation, brace specs/size/type, freestanding winter installation (SKID) options including again sign size, post size, brace type, skid size and skid configuration. Additional hardware specs are noted and include those for panel size, screw size for panels, quantity, placement, size for brace and brace quantity.

Succeeding page 92 (FIG. 9B) references commercial real estate wall installation guidelines, this including such installation specifications as MDO panel size 93, anchor quantity 93′, anchor placement 93″, and the like. FIGS. 9C (page 94) and 9D (page 96) illustrate a plurality of brace specification visuals associated with a given signage installation. Finally, FIG. 9E (sheet 98) discloses a wall installation visual guideline page. It is again understood that each of the screen illustrations 92-98 can be incorporated as pages into the on-line web program associated with the present system.

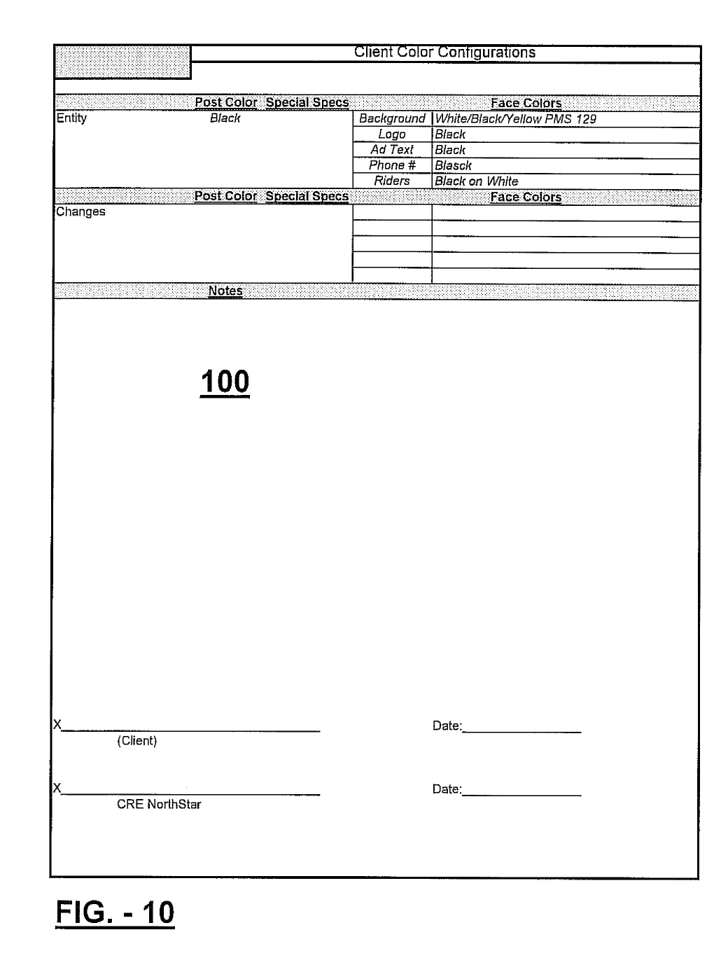

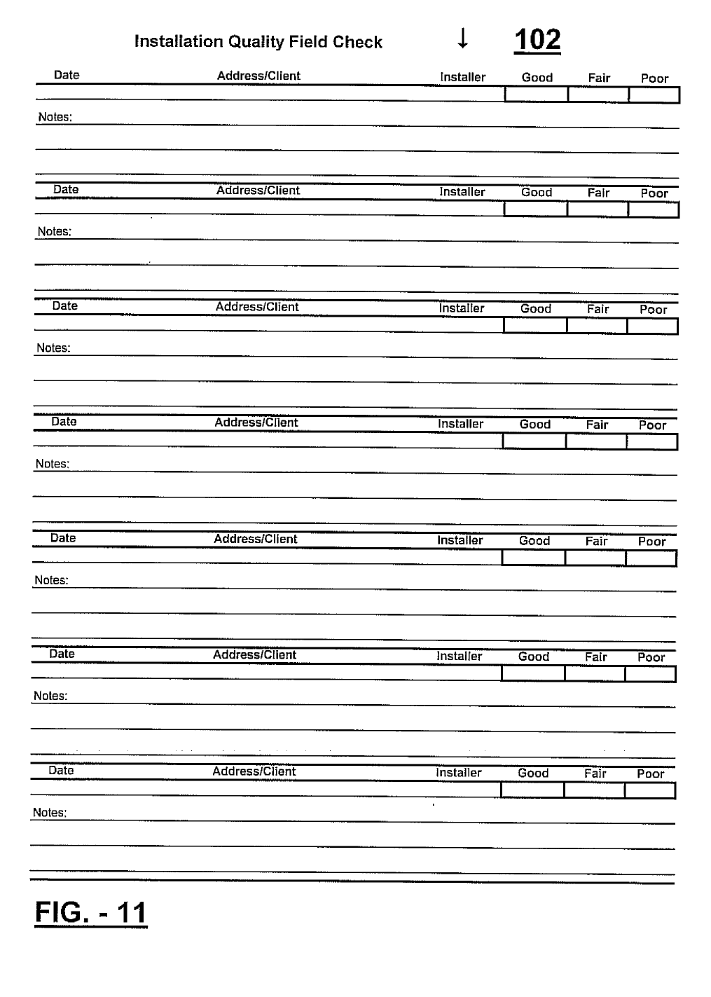

FIG. 10 identifies, at 100, an art details page for customer execution upon proposal acceptance. As with pages 92-98, illustration 100 can be provided as a separate packet and/or can be incorporated into the on-line content of the system. Proceeding to FIG. 11, an installation quality field check form is shown at 102, and which can either by key entered by the user or, in other applications, printed out and filled in.

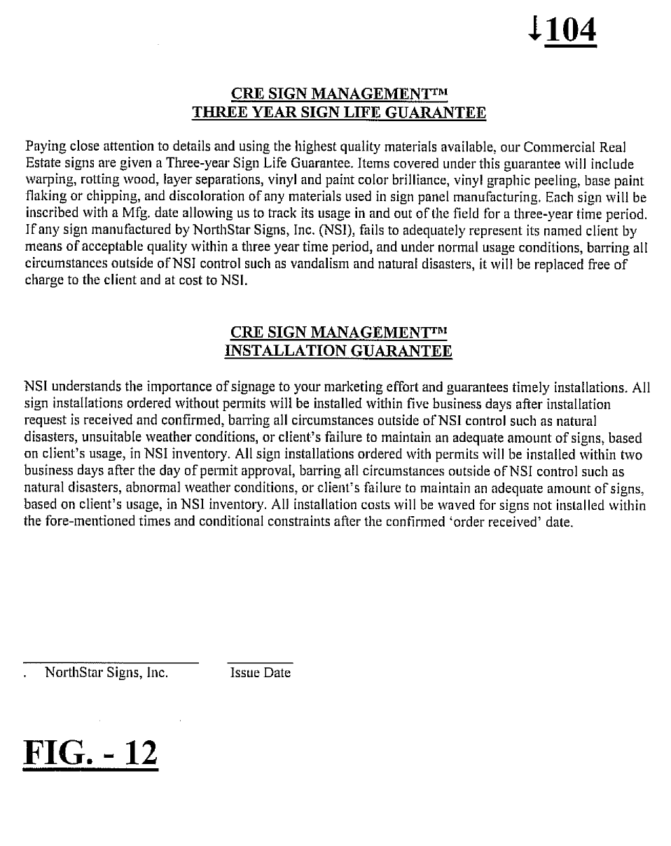

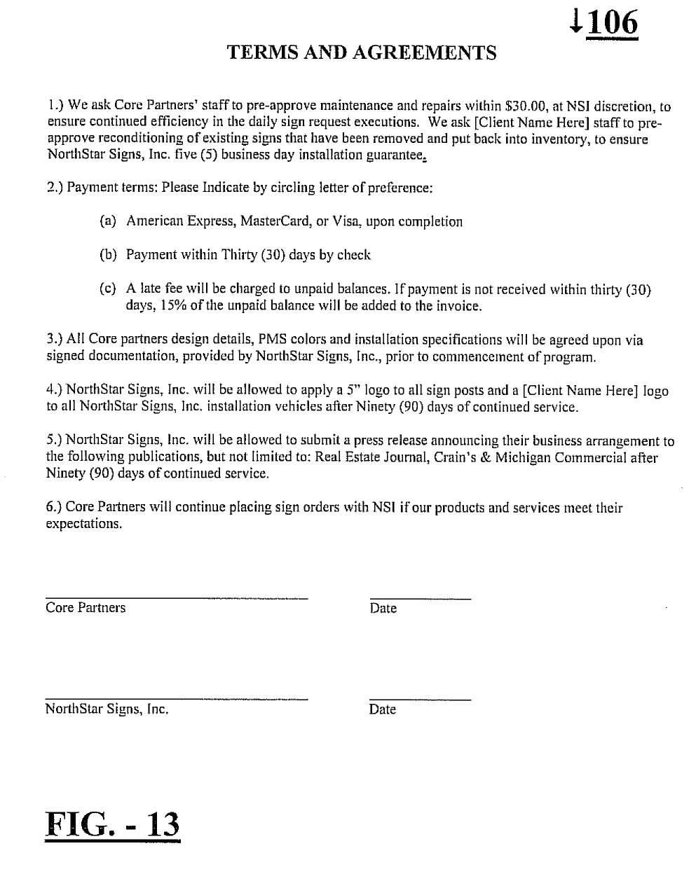

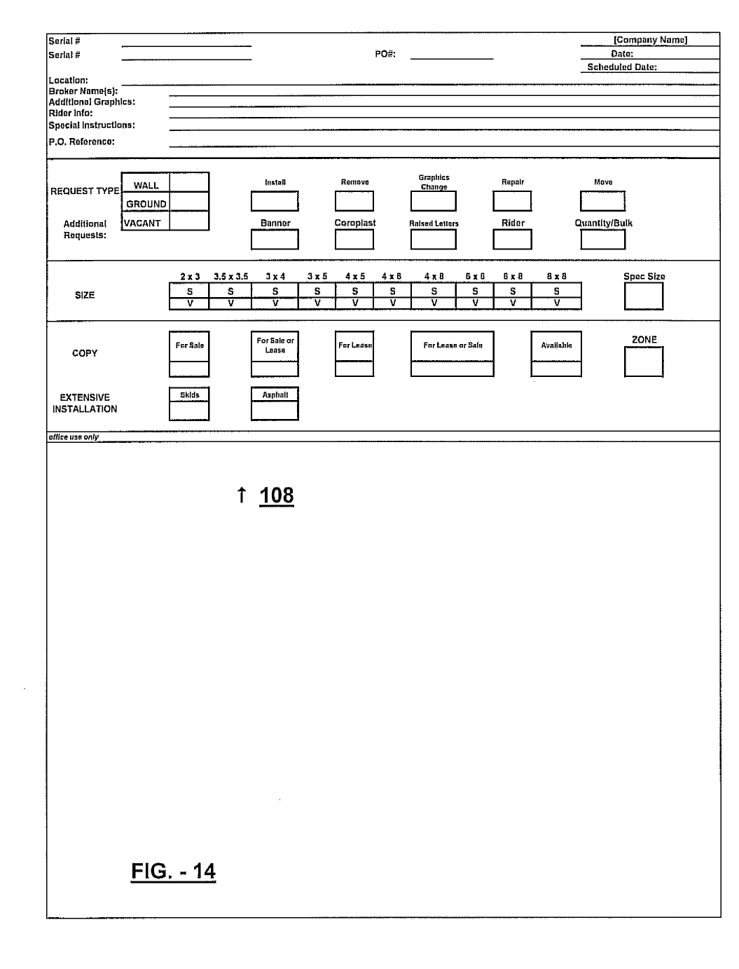

Illustration 104, FIG. 12, is of a product and quality guarantee and FIG. 13 is a proposal acceptance term and agreement page 106 provided to the client/customer upon conditional acceptance. Finally, FIG. 14 is an auxiliary signage order request form 108 for use in the event of interruption to the on-line/web based system. It is again noted that the features of FIGS. 10-14 can be provided as dedicated screens within the computer program and/or can be individually printed out (or provided as additional paper documentation).

The present system and associated computer writeable medium teaches a web-based program particularly suited for managing signage ordering and installation. The present system further enables more effective and seamless incorporation of the most state of the art signage related technology. Having described our invention, other additional embodiments will become apparent to those skilled in the art to which it pertains, and without deviating from the scope of the appended claims.

I claim:

1. An online system for managing residential and commercial signage, comprising the steps of:
a processor driven device in communication, via a network, with a remote processor database;
a program including a first component communicable through said processor device at least one order placement in the creation and installation of any plurality of signage; and
said system further comprising a series of web based illustrations for managing the specifications associated with the created signage, as well as installation specifics and removal.

2. The system as described in claim 1, further comprising a signage repair/update request form.

3. The system as described in claim 1, further comprising an order detail page and providing an administrator with complete access to an entire program associated with said system from a single page, said order detail page including any of the ability to review order details, attach completed job photos and update progress of order for customer and associates in the associated order status section, as well as viewable sections for production, installation, updating and processing of order.

4. The system as described in claim 1, further comprising a local ordinance restriction filter database screen for comparing all relevant city/township/country regulations and codes pertaining to allowable signage parameters.

5. The system as described in claim 1, further comprising an administration item list screen presenting customer price lists including all items which are required in order to calculate the cost of each order/request, and further including size and pricing for individual or all customers.

6. The system as described in claim 1, further comprising a customer job status screen, and by which customers can obtain real time job status of all orders placed, along with completed job/installation photographs.

7. The system as described in claim 1, further comprising a customer order and installation screen, including sub-fields by which all relevant information relating to an installation is added by the customer.

8. A computer writeable medium for an online system for managing residential and commercial signage, comprising:
a first customer accessible subroutine requesting creation and installation of any plurality of signage, and including any of signage size, script, installation type and location, term of installation, repair/update, and removal;
a second administrator viewable subroutine and including any of the ability to review order details, attach completed job photos and update progress of order for customer and associates in the associated order status section, as well as viewable sections for production, installation, updating and processing of order;
a third restriction filter subroutine for comparing all relevant city/township/country regulations/codes/ordinances pertaining to allowable signage parameters; and
a fourth administration item list subroutine for presenting customer price lists including all items which are required in order to calculate the cost of each order/request, and further including size and pricing for individual or all customers.

9. The computer writeable medium as described in claim 8, further comprising a customer job status subroutine, and by which customers can obtain real time job status of all orders placed, along with completed job/installation photographs.

10. The computer writeable medium as described in claim 8, said first customer accessible subroutine further comprising customer order and installation capability with sub-fields by which all relevant information relating to an installation is added by the customer.

11. An online system for managing residential and commercial signage, comprising the steps of:
a first processor driven device in communication, via an on-line connection, with a second remote processor;
a computer website administered through said remote processor and accessible by said first processor, said website incorporating a program for providing order placement terms in the creation and installation of signage; and
said system further comprising a series of web based screens for managing the specifications associated with the created signage, as well as installation specifics and removal.

12. The system as described in claim 11, said website program further comprising a signage repair/update request form.

13. The system as described in claim 11, said website program further comprising an order detail page and providing an administrator with complete access to an entire program associated with said system from a single page, said order detail page including any of the ability to review order details, attach completed job photos and update progress of order for customer and associates in the associated order status section, as well as viewable sections for production, installation, updating and processing of order.

14. The system as described in claim 11, said website program further comprising a local ordinance restriction filter database screen for comparing all relevant city/township/country regulations and codes pertaining to allowable signage parameters.

15. The system as described in claim 1 said website program, further comprising an administration item list screen presenting customer price lists including all items which are required in order to calculate the cost of each order/request, and further including size and pricing for individual or all customers.

16. The system as described in claim 1, said website program further comprising a customer job status screen, and by which customers can obtain real time job status of all orders placed, along with completed job/installation photographs.

17. The system as described in claim 1, said website program further comprising a customer order and installation screen, including sub-fields by which all relevant information relating to an installation is added by the customer.
